(19) United States
(12) Patent Application Publication
(10) Pub. No.: US 2018/0156635 A1
(43) Pub. Date: Jun. 7, 2018

(54) POSITION DETECTOR

(71) Applicant: KNORR-BREMSE GESELLSCHAFT MIT BESCHRÄNKTER HAFTUNG, Mödling (AT)

(72) Inventor: Andreas MAIR, Oberschlierbach (AT)

(21) Appl. No.: 15/576,483

(22) PCT Filed: May 20, 2016
(86) PCT No.: PCT/AT2016/050151

§ 371 Date: Nov. 22, 2017

(30) Foreign Application Priority Data
May 27, 2015 (AT) A50423/2015

(51) Int. Cl. G01D 5/14; F16D 59/00; F16D 63/00; E05F 5/00

(52) U.S. Cl. CPC G01D 5/14; F16D 59/00; F16D 2066/003; F16D 63/002; E05F 5/003; F16D 63/006

(57) ABSTRACT

A device for detecting the current position of an object or component, which can be moved back and forth between two positions by an electromagnetic field, in particular the movable counter-disc of a toothed disc, of a magnetically or electromagnetically operable brake or clutch, in particular in the door drive of a vehicle. To protect the contact projections of the switch used, a separate detector part is provided for detecting the position of the movable component, which can move in the direction of the movement thereof with respect to the movable component, that the detector part, such as the movable component, is under the action of the electromagnetic field which is moving the component, and that the detector part contacts at least one contact projection of the switch in one of the two positions by a switch finger arm and has a distance therefrom in the other position.

### PRIORITY CLAIM

This patent application is a U.S. National Phase of International Patent Application No. PCT/AT2016/050151, filed May 20, 2016, which claims priority to Austrian Patent Application No. A 50223/2015, filed May 27, 2015, the disclosures of which are incorporated herein by reference in their entirety.

### FIELD

Disclosed embodiments relate to a device for detecting the instantaneous position of an object.

### SUMMARY

Disclosed embodiments provide a simple, compact, reliable monitoring device which can, as far as possible, be adapted to switches which are used and which also makes it possible to use different sensors and pursue different strategies and take into account different mounting possibilities without complex changes and adaptations, since there are a wide variety of requirements here depending on the customer.

In accordance with at least one disclosed embodiment, in order to detect the position of the movable part a separate detector plate is provided which can move with respect to the movable clutch part, in the direction of the movability thereof. In this context, the detector part as well as the clutch part are under the effect of the electromagnetic field which moves the clutch part, and under certain circumstances a compression spring is provided between the clutch part and the detector part.

In this simple way it may be ensured that, as a result of the mass and the design of the detector plate, it is possible to determine the effect of the electromagnetic force on the detector plate, that is to say the acceleration thereof, while additionally taking into account the mass and the final speed over the available distance, wherein the compression spring or compression springs is/are provided between the two movable plates in accordance with the forces which occur and the distances which are to be covered, and the characteristic curves thereof are determined.

### BRIEF DESCRIPTION OF THE FIGURES

FIG. 1 shows a purely schematic section through a device according to the disclosed embodiments in the coupled state.

FIG. 2 and FIG. 3 show purely schematic sections through a device according to the disclosed embodiments in the uncoupled state.

### DETAILED DESCRIPTION

Disclosed embodiments relate to a device for detecting the instantaneous position of an object, which can be moved to and fro between two positions by means of an electromagnetic field, in particular the toothed disk, of a magnetically actuable brake or clutch, in accordance with the preamble of claim 1 and of EP 2 002 142 A1.

This document describes what is referred to as a safety brake in which a clutch piece, in the case presented having a toothing arrangement, can be moved to and fro by electromagnetic forces between a position which corresponds to the locked position and a position which corresponds to the released position. There are also similar devices which, instead of a toothing arrangement, have other securing means and/or instead of the electromagnetic forces use springs or other elements in one of the directions.

Such brakes are used in different ways, for example in door drivers for railway doors, but also in lift doors, and also in elevators, in cable pulls and any type of force-transmitting means or torque-transmitting means. There are bistable arrangements in which permanent magnets or mechanical securing means are used to ensure that once an end position has been used it is maintained up to the next switching pulse, and there are monostable designs in which the one end position is assumed as soon as the electromotive force ceases, whether this is desired or whether it is in the course of a fault. Which of these brakes is used depends on the respective application area and on the safety approach of the user.

For all these types of brakes it is significant to communicate the instantaneous (current) position of a closed-loop and open-loop control device, in order to monitor this position and to be able to subsequently adjust the operation of the entire system which is connected to the brake. Such monitoring of the actual state independently of the past switching instructions, is essential both for the sequencing of the various operating steps to be performed and for safety. It is therefore necessary to ensure that this detection takes place reliably and without faults.

This has been achieved in the prior art in that the movable component of the brake has been permanently provided with an arm or the like, if appropriate also in one piece, and in that the end of the arm which therefore inevitably moves along with the movable part, contacts, actuation means (pins or the like) are provided which make contact with a switch, plug or the like which is correspondingly permanently mounted opposite, and therefore closed or opened a circuit or, which was to be aimed at on various occasions for technical adjustment reasons, operated a plurality of such switching elements, wherein it was certainly also possible to open some and close others, depending on their position and effect in one of the closed-loop or open-loop control circuits.

This concept, which has the great advantage of being connected directly to the movable part and of therefore representing its position directly, has the disadvantage that the movement of the movable part is prescribed by its function of engaging or releasing, and is therefore not able to allow for mechanical, dynamic, electrical or other conditions and limits of the sensor part. In particular, the speed of movement of the moved component lies, even if not exclusively, significantly above switching speeds which are permissible for the switching relays etc. which are used and can be used. The consequence is the need to provide levers and the like by means of which the speed or speeds of the moved component are reduced, but which in turn proportionally reduces the distances which have been covered by contact elements, and therefore in turn makes more sensitive switches etc. necessary. Furthermore, movable parts are contradictory and costly because of immediacy which is aimed at. Such parts are known from JPS61211539 (A). DE91 11 784 U1 and also U.S. Pat. No. 3,400,797 A avoid the need for the levers etc. but instead submit the switch to the direct force of the movable part.

Another possibility is to use contactless switches such as are known from DE 10 2006 004 065 A1, DE 20 2005 009 053 U1 and DE 199 22 251 A1. The problems which occur here are in the characteristic curves relating to the hysteresis of the proximity switches and the travel of the movable part and the influence on the proximity switches from other elements and also soiling in rough operating conditions.

WO 97/42118 A1 discloses correspondingly controlling the magnetic force in an elevator brake, therefore in a well-defined and protected environment, in order to achieve gentle inward movement of the movable part. This measure is complex and requires fine adjustment and maintenance when the mechanical properties unavoidably change in the course of operation, without mentioning changes, for example, in the open air.

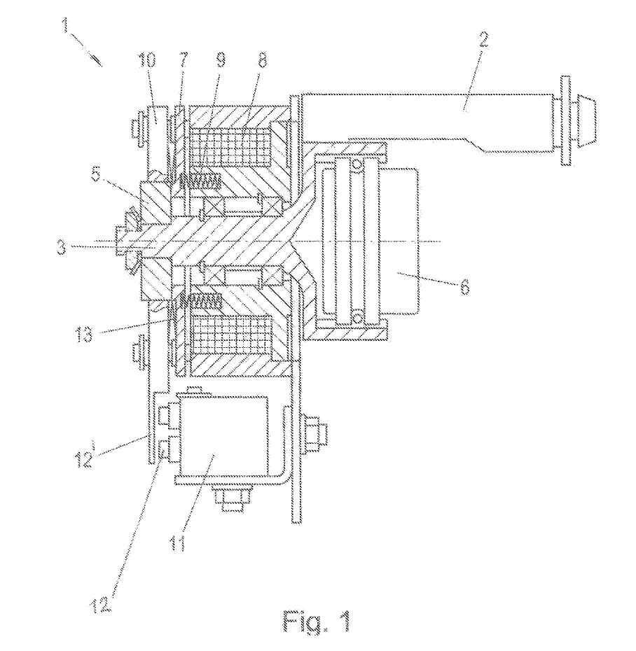

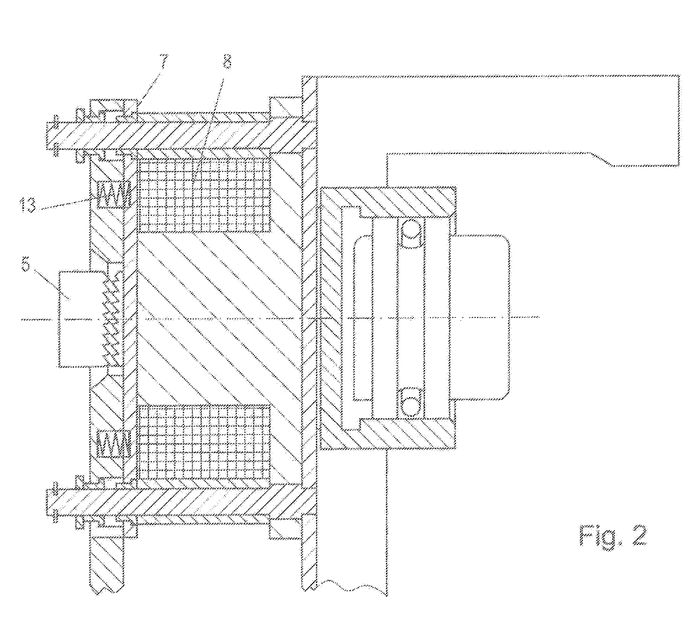

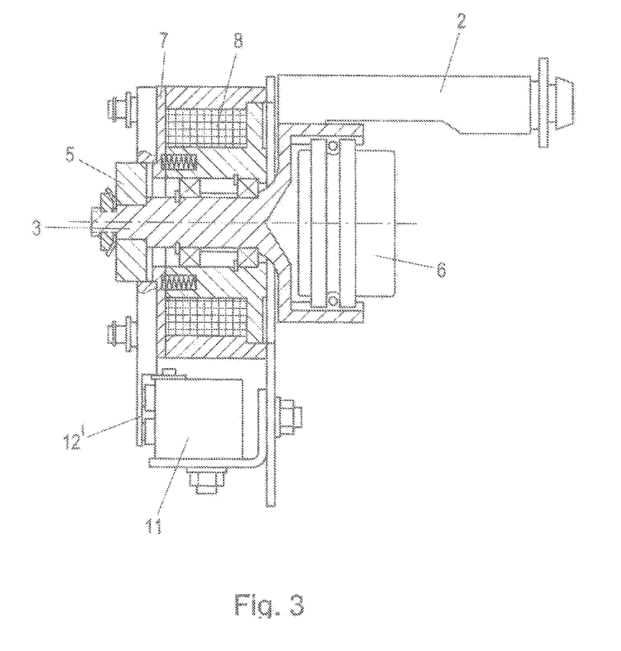

With this understanding of the conventional art in mind, the disclosed embodiments will be explained in more detail below with reference to an exemplary embodiment. In this context, FIG. 1 shows a purely schematic section through a device according to the disclosed embodiments in the coupled state, and FIG. 2 and FIG. 3 in the uncoupled state.

A brake 1 which is selected as an example is attached in a suitable way to a wing 2 or to another mounting part on the non-illustrated railway car body or door frame and there is in its interior a shaft 3 which can rotate about an axis 4. The shaft 3 is connected in a rotationally fixed and axially fixed fashion to a toothed ring 5 (FIG. 2) and has, at its other end, a connection to a free wheel 6, which is itself seated on an activation shaft (not illustrated).

This device serves, for example during the actuation of railway doors, to always allow a rotation of the actuation shaft in the direction in which the free wheel permits it (usually the closing direction of the door), but to prevent a rotation in the opening direction. If a rotation in this direction, which the free wheel 6 does not permit, is then desired, the brake 1, that is to say in detail the toothed disk 5, is released and the actuation shaft can then rotate in the other direction, together with the free wheel and the shaft 3 and the toothed disk 5.

In order to bring about this release, a counter-disk 7 is arranged in a rotationally fixed fashion in the brake 1, which counter-disk 7 is, however, movable between two positions in the direction of the axis 4. FIG. 1 shows the closed or blocking position in which a toothed ring of the movable disk 7 meshes with the teeth of the toothed disk 5, and therefore prevents it from making any rotation. FIG. 2 and FIG. 3 show the situation in the released state, in which the disk 7 has been pulled by electromagnetic forces of a magnet 8 so far to the right in the figures that the toothing arrangements of the two toothing cones disengage, and the toothed disk 5 and therefore the shaft 3 can rotate freely. When the magnet 8 is switched off, the movable disk 7 is forced again into the blocking position by springs 9. What was stated in the introduction, that, instead of this monostable embodiment, a bistable design is possible by providing permanent magnets or the like applies here; however, this is nothing to do with the disclosed embodiments which will be explained in more detail with reference to this example.

In order to be able to signal the current position of the movable disk 7 to a corresponding closed-loop or open-loop control device (not illustrated), a detector disk 10 is provided, which like the movable disk 7, is mounted in a rotationally fixed fashion with respect to the brake 1, but is movable in the direction of the axis 4. This detector disk 10 is then also attracted by the magnet 8, as is the movable disk 7, but has such a magnetic property and such a mass that in the case of the activation of the magnet 8 and the movement of the movable disk 7 its own movement only reaches a speed which is low enough such that during the contact with its contact projection or projections 12 the actual switch (always referred to as such below, no matter what its design is) 11 is stressed beyond the stability of the contact projection or projections 12. This situation is illustrated in FIG. 3.

The switching process of the magnet can also be made plausible here by means of current measurement. The switching process is defined here by a characteristic current profile.

During the switching off of the electromagnet 8, the compression springs 9 in turn move the movable plate 7 into the locked position (FIG. 1), and the intermediate springs 13 or suitably arranged permanent magnets or another propulsion element press the detector disk 10 together with its switching finger arm 12′, away from the switch 11, which transmits this movement or the reaching of the end of this movement to the control device.

These elements 13 are dimensioned in their characteristic curve and in their maximum dimension in such a way that in the event of a fault, for example if the movable disk 7 does not move into the locked position (FIG. 1) despite the switching off of the magnet 8, i.e. is not pressed away by the switch 11, the locked state is not erroneously signaled. Given knowledge of the disclosed embodiments and the components which are used and the field of use it is possible for this to be easily determined by a person skilled in the art by calculation, possibly a number of simple tests.

If, conversely, the movable disk 7 is not decoupled despite the magnet 8 being switched on, as result of the sprung elements 13 the contact 12 does not move into the region of the switch 11 either, after which the switch 11 signals, as before, that as before the locked position is present.

The disclosed embodiments can be configured in a variety ways and adapted to the respective field of application. Given knowledge of the disclosed embodiments, it is clear for a person skilled in the art of the adjustment of control equipment in the field of electromagnetically actuated devices to select the corresponding parameters, in particular for this purpose he has the spring elements 13, the mass of the detector disk 10, the distance from the magnet 8, the magnetic properties of the detector disk 10, and to do this with respective coordination with the mass properties and magnetic properties of the movable disk 7 and the strength of the restoring spring 9.

Finally it can be noted that the disclosed embodiments relates to a device for detecting the instantaneous position of an object or component 7, which can be moved to and fro between two positions by means of an electromagnetic field, in particular the movable counter-disk of a toothed disk 5, of a magnetically or electromagnetically actuable brake 1 or clutch, in particular in the door driver of a vehicle such as a railway car. For the protection of the contact projections 12 of the switch 11 which is used here, in order to detect the position of the movable component 7, a separate detector part 10 is provided which can move with respect to the movable component 7 in the direction of the mobility thereof, that the detector part 10 and the movable component 7 are under the effect of the electromagnetic field which moves the component 7, and that in one of the two positions the detector part 10 makes contact with at least one contact projection 12 of the switch 11 by means of a switching finger arm 12′, and in the other position is at a distance therefrom.

### LIST OF REFERENCE NUMBERS

01 Brake
02 Wing
03 Shaft
04 Axis
05 Toothed ring, toothed disk
06 Free wheel
07 Counter-disk, movable disk
08 Electromagnet
09 Springs
10 Detector disk
11 Switch
12 Contact projection
12′ Switching finger arm
13 Springy elements

1. A device for detecting the instantaneous position of an object or component, which can be moved between two positions by an electromagnetic field the device comprising:
a detector part configured to move with respect to the movable component in the direction of the mobility thereof, wherein the detector part and the movable component are under the effect of the electromagnetic field which moves the component; and
at least one switch contact projection, wherein, in one of the two positions the detector part makes contact with the at least one switch contact projection by a switching finger arm, and wherein, in the other position, is positioned at a distance away from the at least one switch contact projection.

2. The device of claim 1, further comprising a pressure element, which comprises at least one compression spring provided between the movable component and the detector part.

3. The device of claim 1, further comprising a pressure element, which comprises at least one permanent magnet provided between the movable component and the detector part.

4. The device of claim 1, wherein the detector part assumes the contact-forming position when the electromagnetic field is applied.

5. The device of claim 1, wherein the object or component is movable counter-disk of a toothed disk.

6. The device of claim 5, wherein the movable counter-disk of the toothed disk is part of a magnetically or electromagnetically actuable brake or clutch.

7. The device of claim 6, wherein the magnetically or electromagnetically actuable brake or clutch is part of a door driver of a transportation vehicle.

8. A railway door driver that includes a magnetically or electromagnetically actuable brake or clutch that comprises:
a movable counter-disk of the toothed disk, which can be moved between two positions by an electromagnetic field; and
a device for detecting the instantaneous position of the movable counter-disk, wherein the device includes a detector part configured to move with respect to the movable counter-disk in the direction of the mobility thereof, wherein the detector part and the movable counter-disk are under the effect of the electromagnetic field which moves the movable counter-disk, and at least one switch contact projection, wherein, in one of the two positions the detector part makes contact with the at least one switch contact projection by-a switching finger arm, and wherein, in the other position, is positioned at a distance away from the at least one switch contact projection.

9. The railway door driver of claim 8, wherein the detection device further comprises a pressure element, which comprises at least one compression spring provided between the movable counter-disk and the detector part.

10. The railway door driver of claim 8, wherein the detection device further comprises a pressure element, which comprises at least one permanent magnet provided between the movable counter-disk and the detector part.

11. The railway door driver of claim 8, wherein the detector part assumes the contact-forming position when the electromagnetic field is applied.
